(19) United States
(12) Patent Application Publication
(10) Pub. No.: US 2006/0187398 A1
(43) Pub. Date: Aug. 24, 2006

(54) Method of manufacturing liquid crystal device, liquid crystal device, liquid crystal display, and projection system

(75) Inventors: Tadaaki Isozaki, Kanagawa (JP); Shunichi Hashimoto, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/345,697

(22) Filed: Feb. 2, 2006

(30) Foreign Application Priority Data
Feb. 3, 2005 (JP) P2005-027365

(51) Int. Cl. G02F 1/1339

(52) U.S. Cl. 349/153; 349/190

(57) ABSTRACT

In a method of manufacturing a liquid crystal device, first and second substrates are provided. A UV-curable adhesive is applied to a peripheral portion of at least one of the opposed surfaces the first and second substrates, the UV-curable adhesive having a glass transition point. The first substrate is adhered to the second substrate so as to define a predetermined spacing therebetween. The adhesive is cured by irradiation with UV rays and thereafter heated at a temperature higher than the glass transition point of the adhesive. A liquid crystal is then sealed in the predetermined spacing between the first and second substrates.

### CROSS-REFERENCE TO RELATED APPLICATIONS

The present application claims priority from Japanese Patent Application No. JP 2005-027365 filed on Feb. 3, 2005, the disclosure of which is hereby incorporated by reference herein.

### BACKGROUND OF THE INVENTION

The present invention relates to a method of manufacturing a liquid crystal device such that two substrates are adhered to each other with a predetermined spacing therebetween and a liquid crystal sealed between the substrates is driven, a liquid crystal device, a liquid crystal display, and a projection system.

In the liquid crystal display device as described, for example, in Japanese Patent Laid-open No. 2004-333986, the adhesives to be used for adhering two substrates to each other are classified into two types, i.e., the type of having both a UV-curable component and a heat-curable component (UV/heat-curable type) and the type of having only a UV-curable component (UV-curable type).

In using the former type, a heat treatment for curing the adhesive would be inevitable. In using the latter type, on the other hand, a heat treatment may not necessarily be conducted, but a heat treatment promises more assured curing. If an uncured component is left in the adhesive, the uncured component might be mixed into the liquid crystal material, thereby deteriorating the aligned state of the liquid crystal or spoiling the reliability of the liquid crystal material itself. In other words, in using the adhesive for adhering the substrates of a liquid crystal display device, the heating step is for minimizing the amount of the uncured component and for preventing the device reliability from being spoiled. Accordingly, it is desirable to treat the adhesive at a temperature required for the progress of the curing reaction according to the chemical component(s) constituting the adhesive, the temperature being ordinarily 100 to 120° C.

On the other hand, all the liquid crystal display devices have the problem that the long-term reliability of the device may be spoiled due to the penetration of atmospheric moisture into the device through the liquid crystal feeding-in port or the gap between the two substrates. When the devices are left to stand under hot and humid conditions for evaluation of this phenomenon in an accelerated mode, it is found that a change is generated in liquid crystal alignment of the devices due to the influence of penetration of moisture. In addition, since water as an impurity is mixed into the liquid crystal, unevenness of display or the like appears.

To cope with this problem, an adhesive material low in water vapor permeability may be needed as the adhesive, but it has not succeeded in solving the problem. This means that the moisture penetration into the device is not only through the adhesive material itself, and it may be necessary to take other routes into account. Besides, the phenomenon in the vicinity of the liquid crystal feeding-in port is not particularly conspicuous, and similar worsening of the liquid crystal quality is observed over substantially the whole area.

### SUMMARY OF THE INVENTION

According to an embodiment of the present invention, there is provided a method of manufacturing a liquid crystal device including providing a first substrate having a first surface and a second substrate having a first surface; applying a UV-curable adhesive in an application width to a peripheral portion of the first surface of at least one of the first and second substrates, the UV-curable adhesive having a glass transition point; adhering the first substrate to the second substrate so that the first surface of the first substrate confronts the first surface of the second substrate with a predetermined spacing between the first and second substrates; irradiating the UV-curable adhesive with UV rays to cure the UV-curable adhesive; heating the cured adhesive for a heating time and at a heating temperature higher than the glass transition point of the adhesive; and sealing a liquid crystal in the predetermined spacing between the first and second substrates.

In such an embodiment of the present invention, in curing the UV-curable adhesive used for adhering the first substrate to the second substrate, the curing by irradiation with UV rays is followed by heating at a temperature higher than the glass transition point of the UV-curable adhesive so that the UV irradiation cured adhesive itself is softened by the heating at the temperature higher than its glass transition point, whereby adhesion at the interfaces between the adhesive and the substrates is enhanced.

In addition, according to another embodiment of the present invention, there is provided a liquid crystal device including a first substrate having a first surface; a second substrate having a first surface; a UV-curable adhesive disposed in an application width on peripheral portions of the first and second substrates and adhering the first substrate to the second substrate so as to define a predetermined spacing therebetween; the UV-curable adhesive having a glass transition point and having been cured by irradiation with UV rays and thereafter heated for a heating time and at a heating temperature higher than the glass transition point of the UV-curable adhesive; and a liquid crystal sealed in the predetermined spacing between the first and second substrates. Furthermore, according to further embodiments of the present invention, there are provided a liquid crystal display and a projection system which are configured using the liquid crystal device according to the present invention.

In the embodiments of the present invention, the UV-curable adhesive used for adhering the first substrate to the second substrate is cured by irradiation with UV rays and thereafter heated at a temperature higher than its glass transition point, whereby adhesion between the adhesive and the substrates is enhanced, and the sealing quality of the inside of the liquid crystal can be enhanced.

Therefore, according to the present invention, in adhering the first and second substrates for constituting the liquid crystal device by the UV-curable adhesive, the amount of moisture penetrating into the inside of the device via the interfaces between the adhesive and the substrates can be reduced, the display quality can be maintained over a long period of time, and the product life concerning panel contrast can be prolonged.

### BRIEF DESCRIPTION OF THE DRAWINGS

FIG. 1 is a schematic sectional diagram illustrating the structure of a liquid crystal device according to an embodiment of the present invention;

FIG. 2 shows characteristics obtained in Examples of the present invention and Comparative Example; and

FIGS. 3A and 3B show the reflectance values under no electric field when the width of an adhesive is varied.

### DETAILED DESCRIPTION

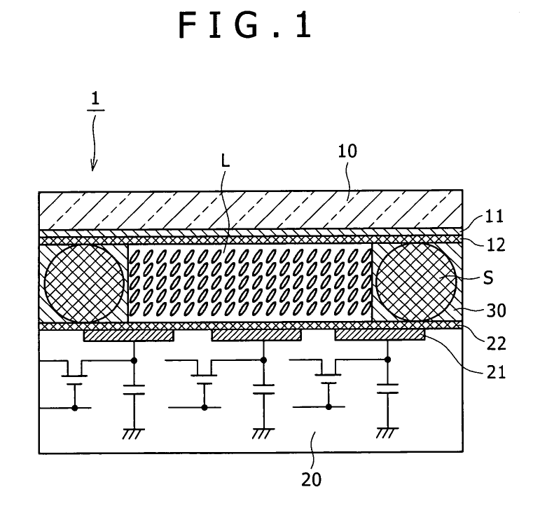

Now, an embodiment of the present invention will be described below, referring to the drawings. FIG. 1 is a schematic sectional diagram illustrating the basic structure of a liquid crystal device according to the present embodiment. The liquid crystal device 1 is composed of a reflection type liquid crystal display device, wherein a glass substrate (first substrate) 10 and a driving substrate (second substrate) 20 are adhered to each other, with a predetermined gap therebetween, and a liquid crystal L is sealed in the gap and is driven.

The liquid crystal device 1 includes the driving substrate 20 composed of a silicon (Si) or the like single crystal semiconductor substrate provided with light-reflective electrodes 21 having a pixel structure, and the glass substrate 10 which is a transparent substrate provided with a transparent electrode 11 and which is opposed to the driving substrate 20, with the liquid crystal L being sealed between the two substrates. The vertically aligned or the like liquid crystal L is aligned by alignment films 12 and 22 formed on the opposed surfaces of the glass substrate 10 and the driving substrate 20, respectively.

The reflection type liquid crystal display device has a configuration in which a drive circuit composed of transistors, each composed of CMOS (Complementary Metal Oxide Semiconductor) or n-channel MOS (Metal Oxide Semiconductor), and capacitors is formed in the single crystal silicon substrate to constitute the driving substrate 20, and the light reflective electrodes 21 are formed thereon by use of a metallic film of Al (aluminum), Ag (silver) or the like to constitute the pixel structure. The light reflective electrode 21 functions both as a light-reflecting film and as an electrode for applying a voltage to the liquid crystal.

Incidentally, a dielectric multi-layer film may be formed on the metallic film, for enhancing the reflectance or as a protective film for the metallic surface.

The two substrates are adhered and fixed to each other by use of an adhesive 30 in which spacers S are mixed for keeping constant the thickness of the adhesive 30. The spacers S are spherical, and are mixed in the adhesive 30 in a proportion of about 0.5 to 5 wt %. In the practical device, the spacers S are discretely present in the adhesive 30. In other words, considering the sectional structure of the device, the boundary between the inside of the device and the outside is composed of the adhesive 30 itself in most regions.

Here, a change in the liquid crystal alignment state due to penetration of moisture into the inside of the device can be distinguished by measuring the variation in the reflectance of the liquid crystal L under no electric field. The liquid crystal L is in a normally black mode, i.e., its reflectance is the lowest under no electric field. Since the reflectance is raised when the alignment quality is lowered due to penetration of moisture, the moisture penetration can be quantitatively examined, though indirectly.

Incidentally, the ratio of the maximum reflectance under an applied voltage to the reflectance under no electric field is called “panel contrast”. A rise in the reflectance under no electric field leads to a lowering in the panel contrast, which is one of important performances of the panel, and, therefore, it is more preferable that the variation in the reflectance under no electric field is less. Specifically, when the period of time taken for the generation of a fixed amount of variation in the reflectance under no electric field is doubled, the product life concerning the panel contrast is doubled.

As for the penetration of moisture from the outside into the inside of the device, the permeation of water vapor through the adhesive itself and the penetration of moisture through the liquid crystal feeding-in port are not denied. However, it has been found that no difference appears in the variation in reflectance under no electric field even when adhesives differing in water vapor permeability are used. This will be described specifically, using Verification Examples A and B.

### VERIFICATION EXAMPLE A

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the crystal alignment films would be 50 nm thick and the pretilt angle of the liquid crystal would be about 2.5°.

Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C. and a water vapor permeability of 4.8 g/m²·24 hr, as measured according to JIS Z0208) so that the spacing between the substrates would be 1.9 μm. The width of the adhesive was set to 1 mm. After the adhesive was cured by irradiation with UV rays, the adhesive was baked at 150° C. for 1 hr. Thereafter, a liquid crystal (refractive index anisotropy Δn=0.111, dielectric anisotropy Δ∈=−7) produced by Merck & Co., Inc. was sealed in the gap between the substrates, to produce a reflection type liquid crystal display device.

The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 2.2, and the ratio of the value after 500 hr of leaving to the value before leaving was 5.0.

### VERIFICATION EXAMPLE B

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°.

Thereafter, both the substrates provided with the respective liquid crystal alignment films were adhered to each other by use of an adhesive containing glass beads mixed therein (a UV-curable adhesive produced by Kyoritsu Chemical & Co., Ltd. having a glass transition temperature of 130° C. and a water vapor permeability of 25 g/m²·24 hr, as measured according to JIS Z0208) so that the spacing between the substrates would be 1.9 μm. The width of the adhesive was set to 1 mm. After the adhesive was cured by irradiation with UV rays, the adhesive was baked at 140° C. for 1 hr for completely curing the adhesive. Thereafter, a liquid crystal (Δn=0.111, Δ∈=−7) produced by Merck & Co., Inc. was sealed in the gap between the substrates, to produce a reflection type liquid crystal display device.

The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 2.4, and the ratio of the value after 500 hr of leaving to the value before leaving was 5.5.

The water vapor permeability was 4.8 g/m²·24 hr in Verification Example A and 25 g/m²·24 hr in Verification Example B, but the use of the adhesives thus differing in water vapor permeability resulted in no conspicuous difference in the variation in reflectance under no electric field. Therefore, it is seen that no difference appears in the variation in reflectance under no electric field even when adhesives different in water vapor permeability were used.

Next, an example in which the same adhesive, the same heating temperature and the same heating time as those in Verification Example A were used and only the coating width was changed from that in Verification Example A will be shown below as Verification Example C.

### VERIFICATION EXAMPLE C

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 2 mm. After the adhesive was cured by irradiation with UV rays, the adhesive was baked at 150° C. for 1 hr for completely curing the adhesive. Thereafter, a liquid crystal (Δn=0.111, Δ∈=−7) produced by Merck & Co., Inc. was sealed in the gap between the substrates, to produce a reflection type liquid crystal display device.

The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 1.2, and the ratio of the value after 500 hr of leaving to the value before leaving was 1.8.

A comparison between Verification Examples A and C shows that a drastic effect on moisture penetration is produced when the coating width of the adhesive is doubled. Besides, the comparison between Verification Examples A and B has shown that the water vapor permeability of the adhesive itself has little influence on the moisture penetration. Therefore, it can be said that the drastic effect is not caused directly by the increase in the coating width of the adhesive itself but is due to the increase in the areas of the interfaces between the adhesive and the substrates.

Here, the characteristics obtained in the case where the same adhesive was applied in the same width as in Verification Example A but the adhesive was cured by only irradiation with UV rays (without heating) in adhering the substrates to each other by use of a UV-curable adhesive will be shown below as Comparative Example.

### COMPARATIVE EXAMPLE

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 1 mm. After the adhesive was cured by irradiation with UV rays, a liquid crystal (Δn=0.111, Δ∈=−7) produced by Merck & Co., Inc. was sealed in the gap between the substrates, to produce a reflection type liquid crystal display device.

The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 7.4, and the ratio of the value after 500 hr of leaving to the value before leaving was 28.

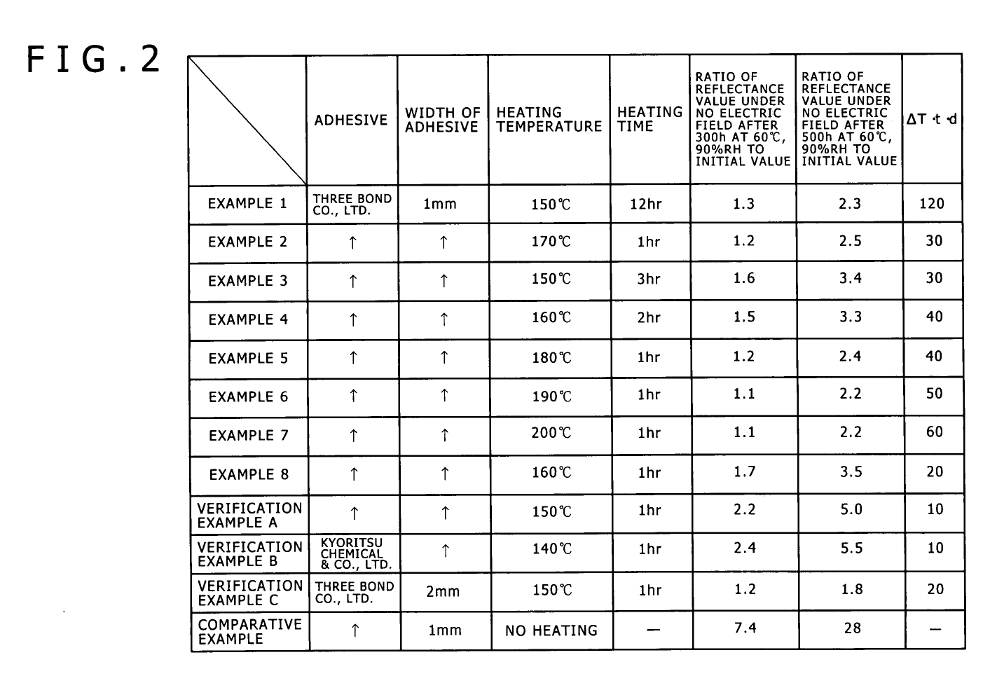

Based on Verification Examples and Comparative Example as above, the present inventors have made various investigations, and have found out that the adhesion at the interfaces between the adhesive 30 and the substrates is important. Specifically, after the UV-curable adhesive 30 is cured by irradiation with UV rays, the adhesive is heated at a temperature higher than the glass transition point of the adhesive 30, whereby the adhesion at the interfaces between the adhesive 30 and the substrates is enhanced. This is to be understood from the fact that Verification Examples A and B (with heating) showed enhancement of reflectance under no electric field, as compared with the reflectance under no electric field in Comparative Example (without heating). FIG. 2 shows the characteristics in Examples of the present invention, Verification Examples, and Comparative Example.

Examples given below are examples in which the step of maintaining the reflection type liquid crystal display device at a temperature of not lower than the temperature at which the adhesive itself is softened (glass transition temperature) is added, for enhancing the adhesion at the interfaces between the adhesive and the substrates without changing the width of the adhesive.

### EXAMPLE 1

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 1 mm. After the adhesive was cured by irradiation with UV rays, the adhesive was baked at 150° C. for 12 hr. Since the glass transition temperature of the adhesive is 140° C., the cured adhesive is softened by the baking, and is thereby better adhered to the substrates.

Thereafter, a liquid crystal (Δn=0.111, Δ∈=−7) produced by Merck & Co., Inc. was sealed in the gap between the substrates, to produce a reflection type liquid crystal display device. The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 1.3, and the ratio of the value after 500 hr of leaving to the value before leaving was 2.3.

### EXAMPLE 2

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 1 mm. After the adhesive was cured by irradiation with UV rays, the adhesive was completely cured, and was baked at 170° C. (higher than the glass transition temperature by 30° C.) for 1 hr. Thereafter, a liquid crystal (Δn=0.111, Δ∈=−7) produced by Merck & Co., Inc. was sealed in the gap between the substrates, to produce a reflection type liquid crystal display device. The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 1.2, and the ratio of the value after 500 hr of leaving to the value before leaving was 2.5.

### EXAMPLES 3 TO 7

In each of Examples 3 to 7, a vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 1 mm. After the adhesive was cured by irradiation with UV rays, the adhesive was completely cured, and was baked at a temperature of 150 to 200° C. (higher than the glass transition temperature of the adhesive) for a period of time of 1 to 3 hr. Thereafter, a liquid crystal (Δn=0.111, Δ∈=−7) produced by Merck & Co., Inc. was sealed in the gap between the substrates, to produce a reflection type liquid crystal display device. The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was in the range of 1.1 to 1.6, and the ratio of the value after 500 hr of leaving to the value before leaving was in the range of 2.2 to 3.4.

### EXAMPLE 8

A vertically-aligned liquid crystal device was produced as follows. A glass substrate provided thereon with a transparent electrode and an Si drive circuit substrate provided with Al electrodes were cleaned and were then introduced into a vapor deposition apparatus, and SiO₂ films as liquid crystal alignment films were formed on the substrates by oblique vapor deposition at a vapor deposition angle in the range of 45 to 60°. The vapor deposition was so controlled that the liquid crystal alignment films would be 50 nm thick and the pretilt angle of the liquid crystal would be about 2.5°. Thereafter, both the substrates provided with the respective liquid crystal alignment films were adhered to each other by use of an adhesive containing glass beads mixed therein (a UV-curable adhesive produced by Three Bond Co., Ltd.; having a glass transition temperature of 140° C.) so that the spacing between the substrates would be 1.9 μm. The width of the adhesive was set to 1 mm. After the adhesive was cured by irradiation with UV rays, the adhesive was baked at 160° C. for 1 hr for completely curing the adhesive. The conditions of 160° C. and 1 hr are a temperature and a time for completely curing the adhesive. Thereafter, a liquid crystal (Δn=0.111, Δ∈=−7) produced by Merck & Co., Inc. was sealed in the gap between the substrates, to produce a reflection type liquid crystal display device.

The reflection type liquid crystal display device was left to stand in a hot and humid tank set to a temperature of 60° C. and a relative humidity of 90% for a predetermined time, and reflectance under no electric field was measured. The ratio of the value of reflectance under no electric field after 300 hr of leaving to the value before leaving was 1.7, and the ratio of the value after 500 hr of leaving to the value before leaving was 3.5.

### EXAMPLES WITH DIFFERENT COATING WIDTHS

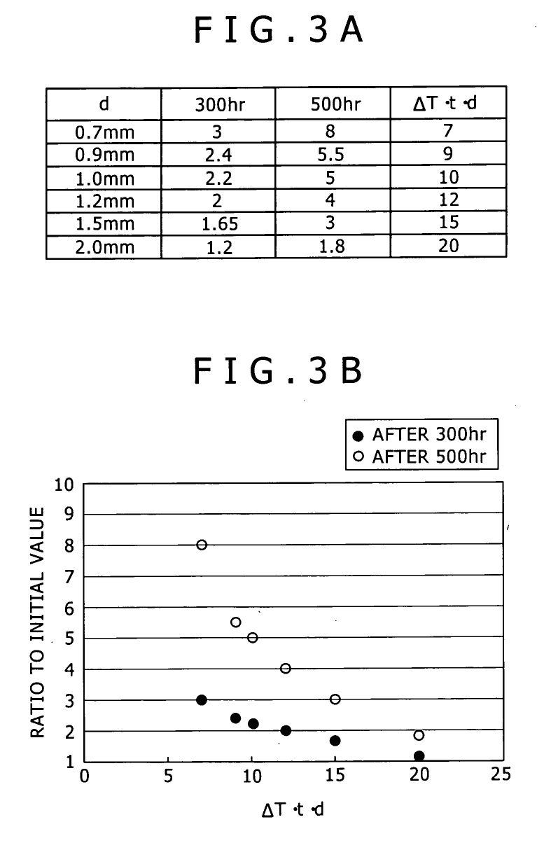

While the width of the adhesive was 1 mm in all of Examples 1 to 8 above, in an example shown in FIGS. 3A and 3B, there is shown the reflectance under no electric field when the coating width of the UV-curable adhesive is varied, with the heating temperature of 150° C. and the heating time of 1 hr after the UV curing of the UV-curable adhesive being the same as in Examples 1 to 8.

Specifically, here, with the coating width of the adhesive set respectively to 0.7 mm, 0.9 mm, 1.0 mm, 1.2 mm, 1.5 mm, and 2.0 mm, the values of reflectance after 300 hr and 500 hr under no electric field were measured. FIG. 3A is a table showing the reflectance values in the cases of the respective coating widths, and FIG. 3B is a graph showing the reflectance values in the cases of the respective coating widths.

Incidentally, in the graph shown in FIG. 3B, the value of ΔT·t·d is taken on the axis of abscissas, where ΔT (unit: ° C.) is the temperature difference between the heating temperature in heating the UV-curable adhesive and the glass transition point of the adhesive, t (unit: hr) is the heating time in heating the adhesive, and d (unit: mm) is the coating width of the adhesive, whereas the reflectance under no electric field is taken on the axis of ordinates.

Here, as the quality of a liquid crystal device 1 in general, it is desirable that the reflectance after 300 hr under no electric field is not more than 2 (the reduction in contrast is not more than one half of the initial value), and, therefore, Examples 1 to 8 satisfy this condition. Besides, it is seen that in the examples with the coating width of the adhesive varied as shown in FIGS. 3A and 3B, the condition is satisfied when the value of ΔT·t·d is not less than 12. Incidentally, in all of Examples 1 to 8, the values of ΔT·t·d are not less than 20, which all satisfy the condition of being not less than 12.

Therefore, in adhering the substrates by use of a UV-curable adhesive in the liquid crystal device 1, it is desirable to conduct the heating at a temperature higher than the glass transition point of the adhesive after the UV curing so that the value of ΔT·t·d is not less than 12.

Besides, as a further favorable condition, it is desirable that the reflectance after 500 hr under no electric field is not more than 2.5; therefore, it is favorable that the value of ΔT·t·d is not less than 20 and ΔT is not less than 30° C., and that the value of ΔT·t·d is not less than 20 and d is not less than 2 mm even if ΔT is less than 30° C.

In the liquid crystal device 1 to which Examples described above are to be applied, general polyimides may be used for forming the alignment films 12 and 22, but an inorganic film (e.g., SiO₂ film) may be used as at least one of the alignment films 12 and 22. An alignment film composed of an inorganic film is high in moisture absorbance and, hence, is liable to produce a bad influence on the liquid crystal. In view of this, by applying the above-described Examples, mixing of moisture into the liquid crystal can be effectively restrained even when an alignment film composed of an inorganic film is used, and the bad influence on the liquid crystal can be obviated even when an alignment film composed of an inorganic film is used.

In addition, the liquid crystal device 1 according to the present invention is applicable to the transmission type other than the reflection type pertaining to the above-described Examples. Besides, the liquid crystal device 1 is applicable to a liquid crystal display using the liquid crystal devices 1 as pixel-forming elements and a projection system having the liquid crystal devices 1 disposed on an optical path of an enlarging optical system, according to the present invention. Particularly, unevenness of display of the liquid crystal devices 1 is enlarged in the projection system, by use of the liquid crystal device according to the present invention which is capable of restraining the unevenness of display, it is possible to contrive enhancement of display quality.

It should be understood by those skilled in the art that various modifications, combinations, sub-combinations and alterations may occur depending on design requirements and other factors insofar as they are within the scope of the appended claims or the equivalents thereof.

1. A method of manufacturing a liquid crystal device, said method comprising:
providing a first substrate having a first surface and a second substrate having a first surface;
applying a UV-curable adhesive in an application width to a peripheral portion of the first surface of at least one of the first and second substrates, the UV-curable adhesive having a glass transition point;
adhering the first substrate to the second substrate so that the first surface of the first substrate confronts the first surface of the second substrate with a predetermined spacing between the first and second substrates;
irradiating the UV-curable adhesive with UV rays to cure the UV-curable adhesive;
heating the cured adhesive for a heating time and at a heating temperature higher than the glass transition point of the adhesive; and
sealing a liquid crystal in the predetermined spacing between the first and second substrates.

2. The method of manufacturing a liquid crystal device as set forth in claim 1, wherein the condition
ΔT·t·d≧12
is satisfied, where ΔT is the temperature difference in ° C. between the heating temperature and the glass transition point of the UV-curable adhesive, t is the heating time in hours, and d is the application width of the UV-curable adhesive in mm.

3. The method of manufacturing a liquid crystal device as set forth in claim 2, wherein
ΔT is not less than 30° C.

4. The method of manufacturing a liquid crystal device as set forth in claim 1, wherein the substrate is a glass substrate and the second substrate is a driving substrate.

5. A liquid crystal device, comprising:
a first substrate having a first surface;
a second substrate having a first surface;
a UV-curable adhesive disposed in an application width on peripheral portions of the first and second substrates and adhering the first substrate to the second substrate so as to define a predetermined spacing therebetween;
the UV-curable adhesive having a glass transition point and having been cured by irradiation with UV rays and thereafter heated for a heating time and at a heating temperature higher than the glass transition point of the UV-curable adhesive; and
a liquid crystal sealed in the predetermined spacing between the first and second substrates.

6. The liquid crystal device as set forth in claim 5, wherein the condition
ΔT·t·d≧12
is satisfied, where ΔT is the temperature difference in ° C. between the heating temperature and the glass transition point of the UV-curable adhesive, t is the heating time in hours, and d is the application width of the UV-curable adhesive in mm.

7. The liquid crystal device as set forth in claim 6, wherein
ΔT is not less than 30° C.

8. The liquid crystal device as set forth in claim 5, wherein the first substrate is a glass substrate and the second substrate is a driving substrate.

9. A display comprising:
a housing; and
a plurality of pixel forming elements disposed in the housing, the pixel forming elements being formed by liquid crystal devices, each liquid crystal device including:
a first substrate having a first surface;
a second substrate having a first surface;
a UV-curable adhesive disposed in an application width on peripheral portions of the first and second substrates to and adhering the first substrate to the second substrate so as to define a predetermined space therebetween;
the UV-curable adhesive having a glass transition point and having been cured by irradiation with UV rays and thereafter heated for a heating time and at a heating temperature higher than the glass transition point of the UV-curable adhesive; and
a liquid crystal sealed in the predetermined space between the first and second substrates.

10. A projection system, comprising:
a source of images;
an enlarging optical system for optically enlarging the images, the enlarging optical system having an optical path; and
at least one liquid crystal device disposed in the optical path, the liquid crystal device including:
a first substrate having a first surface;
a second substrate having a first surface;
a UV-curable adhesive disposed in an application width on peripheral portions of the first and second substrates and adhering the first substrate to the second substrate so as to define a predetermined space therebetween;
the UV-curable adhesive having a glass transition point and having been cured by irradiation with UV rays and thereafter heated for a heating time and at a heating temperature higher than the glass transition point of the UV-curable adhesive; and
a liquid crystal sealed in the predetermined space between the first and second substrates.
